(19) United States
(12) Patent Application Publication
(10) Pub. No.: US 2026/0073145 A1
(43) Pub. Date: Mar. 12, 2026

(54) METHOD FOR KEYWORD-BASED INFORMATION SUMMARIZATION USING GENERATIVE AI WITH USER-SPECIFIED KEYWORDS, AND DEVICE THEREFOR

(71) Applicant: SAMSUNG SDS CO., LTD., Seoul (KR)

(72) Inventors: Yuseok JEONG, Seoul (KR); Seungmin BAEK, Seoul (KR)

(73) Assignee: SAMSUNG SDS CO., LTD., Seoul (KR)

(21) Appl. No.: 19/236,107

(22) Filed: Jun. 12, 2025

(30) Foreign Application Priority Data
Sep. 9, 2024 (KR) 10-2024-0122566
Oct. 29, 2024 (KR) 10-2024-0150133

(51) Int. Cl. G06F 40/30; G06F 16/355; G06F 40/289

(52) U.S. Cl. CPC G06F 40/30; G06F 16/355; G06F 40/289

(57) ABSTRACT

A method for keyword-based information summarization using generative AI with user-specified keywords, and a device therefor are proposed, wherein a summary focused on information related to keywords specified by a user is provided by utilizing generative AI such as an LLM, so as to enable the user to obtain satisfactory summary information that accurately matches the user's intention and specific situation such as work, and the method includes an input step of receiving summary target information and one or more keywords, which are specified or input from a user, a summary generation step of causing the generative AI to generate and return a summary of the summary target information with content related to the keywords based on the keywords and the summary target information, and a summary output step of providing a final summary to the user based on the summary returned by the generative AI.

### CROSS REFERENCE TO RELATED APPLICATION

The present application claims priority to Korean Patent Application No. 10-2024-0122566 filed on Sep. 9, 2024 and Korean Patent Application No. 10-2024-0150133 filed on Oct. 29, 2024, the entire contents of which are incorporated herein for all purposes by this reference.

### BACKGROUND OF THE INVENTION

### Field of the Invention

The present disclosure relates to information processing based on generative AI (or Gen AI) and, more particularly, to a method and device for summarizing various kinds of information related to various collaboration systems, i.e., documents, emails, messengers, and the like, built within an organization or company to which users belong on the basis of keywords specified by the users by utilizing generative AI.

### Description of the Related Art

A transformer model, i.e., an attention-based sequence transduction neural network model proposed by Ashish Vaswani et al. of Google Brain in 2017 in a paper titled “Attention Is All You Need” dramatically improves to solve the problems of previous Recurrent Neural Network (RNN) model, etc. Since then, the transformer model has been considered as the de facto standard for implementing Large Language Models (LLMs). Recently, various an LLMs based on the transformer model have been announced, such as OpenAI's ChatGPT, Google's Bard, Meta's LLAMA, Stanford Univesity's Alpaca, and LMSYS.org's Vicuna, thereby opening a new era of generative AI. Nowadays, generative AI such as an LLM is widely used in various fields such as conversational AI (chatbot), document generation and summarization, translation, text analysis and sentiment analysis, coding and programming, information retrieval, education and learning assistance, content creation, games and simulations, speech recognition and speech synthesis, etc.

In addition, in order to utilize generative AI such as an LLM, a Retrieval-Augmented Generation (RAG) architecture is also being utilized significantly. Such a method searches for content semantically similar to users' input queries in vector databases or the like inside or outside organizations or companies and passes the content as the context of the users' queries to the LLM together, so as to prevent hallucination, etc. Recently, the use of generative AI through Copilot interfaces, etc. has been spreading, and various Copilot solutions for individuals or companies are being distributed and used. RAG framework construction is being processed in a manner where data such as conversations and meeting minutes, which are of emails, files, messengers, and the like and stored in solutions, is provided in the context of the LLM, thereby contributing to improve work efficiency.

In particular, as the amount of various kinds of information used in the work of organizations or companies increases these days, the roles of summary functions that extract the main content from long texts or complex information and express them concisely are becoming increasingly important for quick and efficient understanding of the information. As an example, for specific texts (e.g., documents, mails, messengers, etc.) specified by users of various collaboration systems (e.g., drives, mails, messengers, etc.) within companies, it is common to use LLMs to identify and summarize important information.

However, a simple summary function that is provided by the related art and for particular information specified by a user has a limitation that satisfactory summary information is not provided for information each individual user exactly intended. It is still difficult to expect that various types of information (e.g., documents, mails, messengers, etc.) generated in relation to work within organizations or companies to which the users belong are comprehensively considered, and further that customized summary information that matches the specific requirements or work characteristics of the users, or the organizations, companies, or departments to which the users belong is provided.

In addition, the simple summary function provided by the related art has a problem in that there is no way to verify whether a result contains an error or whether the result is an incorrect summary even when summarizing a user's desired information is performed on the basis of information containing incorrect content. Therefore, if a task the user intends to perform by referring to corresponding summary information is a major decision-making task for a corresponding organization, company, department, or the like, this may become a significant risk factor.

### SUMMARY OF THE INVENTION

An objective of the present disclosure is to provide a summary focused on information related to keywords specified by a user by utilizing generative AI such as an LIM, so as to enable the user to obtain satisfactory summary information that accurately matches the user's intention and specific situation such as work.

In addition, another objective of the present disclosure is to provide a method for effectively summarizing various types of information of collaboration systems (e.g., drives, mails, messengers, etc.) built within an organization, company, department, or the like to which a user belongs, on the basis of keywords input or specified by the user by utilizing generative AI such as an LLM.

In addition, a yet another objective of the present disclosure is to provide a method for utilizing generative AI such as an LLM, so as to group keywords input from a user by combining the keywords with high semantic relevance, to further expand each grouped keyword by extracting keywords that have high semantic relevance and are related to the work of an organization, company, department, or the like to which the user belongs, and to perform summarizing on the basis of keyword groups expanded in this way, thereby providing customized summary information that matches the requirements or work characteristics of the individual user or the organization, company, or department to which the user belongs.

In addition, a still another objective of the present disclosure is to provide a summary verification method configure to extract a context semantically similar to a summary by utilizing a database such as a knowledge repository on the basis of an LLM for the generated summary, and further compare extracted context with the summary by utilizing the LLM, so as to find errors or incorrect parts in the summary, thereby improving the reliability of the generated summary.

In a first aspect of the present disclosure, there is provided a method performed on a computing device and for summarizing information based on user-specified keywords by using generative AI, the method including: an input step of receiving summary target information and one or more keywords, which are specified or input from a user; a summary generation step of causing the generative AI to generate and return a summary of the summary target information with content related to the keywords based on the keywords and the summary target information; and a summary output step of providing a final summary to the user based on the summary returned by the generative AI.

Here, the summary target information may be one or more documents, and the one or more documents may be one or more of electronic document files, emails, and messenger texts.

In addition, the method further includes a chunking step of dividing, by the generative AI, the documents in units of chunks able to be input into the generative AI all at once and of which contexts are understandable.

In addition, the method further includes a chunk collection step of collecting the chunks, which are obtained by the division, by combining each chunk with tag information about the divided documents.

In addition, the method further includes a keyword clustering step of causing the generative AI to cluster a plurality of keywords as a basis into one or more keyword groups according to semantic relevance of the plurality of keywords, wherein the one or more keywords input by the user may be the plurality of keywords.

In addition, the method further includes a keyword expansion step of causing the generative AI to recommend one or more terms related to each keyword belonging to the one or more keyword groups, so as to add the terms to the keyword groups on the basis of the one or more keyword groups.

Here, the terms related to each keyword may be the terms related to work of an organization or company to which the user belongs.

In addition, the method further includes a chunking step of dividing the summary target information in units of one or more chunks; and a keyword clustering step of generating one or more keyword groups on the basis of the one or more keywords input by the user, wherein the summary generation step may include a relevance determination step of causing the generative AI to determine relevance between the respective chunks and keyword groups on the basis of the respective chunks and keyword groups.

In addition, the summary generation step may further include a chunk summary generation step of requesting the generative AI to generate and return a summary of each chunk with content related to each keyword group when the respective chunks and keyword groups are determined to have the relevance on the basis of relevance determination results.

In addition, the summary generation step may further include a summarization result text generation step of requesting the generative AI to summarize and organize one or more chunk summaries and generate a summarization result text on the basis of the one or more chunk summaries obtained by iteratively performing the relevance determination step and chunk summary generation step for each combination of the one or more chunks and the one or more keyword groups.

In addition, the method may further include a similar chunk extraction step of causing the generative AI to extract one or more chunks having content similar to that of the summary from a database on the basis of the summary generated in the summary generation step.

In addition, the method may further include a summarization verification step of causing the generative AI to generate feedback on an incorrect part of the content of the summary on the basis of the extracted similar chunks.

In a second aspect of the present invention, there is provided a device including: a processor; and a memory, wherein the memory may include instructions configured to cause the device to implement specific operations for summarizing information based on user-specified keywords by utilizing generative AI when executed by the processor, and the specific operations may include: an input operation of receiving summary target information and one or more keywords, which are specified or input from a user; a summary generation operation of causing the generative AI to generate and return a summary of the summary target information with content related to the keywords based on the keywords and the summary target information; and a summary output operation of providing a final summary to the user based on the summary returned by the generative AI.

### BRIEF DESCRIPTION OF THE DRAWINGS

The attached drawings are included as a part of the detailed description to aid understanding of the present disclosure, and exemplary embodiments and technical features of the present disclosure are described together with the detailed description.

FIG. 1 is a schematic view illustrating a configuration of a summary system 100 configured to perform a method for summarizing information based on user-specified keywords by utilizing generative AI according to one exemplary embodiment of the present disclosure.

FIG. 2 is a flowchart for describing a chunking process of summary target information such as documents, the chunking process being related to a function of a chunking unit 15.

FIG. 3 is a flowchart for describing a keyword clustering process A and expansion process B related to a function of a keyword expansion unit 25.

FIG. 4 is a flowchart for describing a keyword-based summary generation process related to a function of a summary generation unit 35.

FIG. 5 is a flowchart for describing a summary verification process related to a function of a summary verification unit 40.

FIG. 6 is a view illustrating that a final summary 520 generated through keyword-based summarization and obtained through the exemplary embodiment of the present disclosure is compared with a summary 420 generated through general summarization in the related art 400.

FIG. 7 is a view illustrating that a final summary 720 generated through keyword-based summarization and obtained through the exemplary embodiment of the present disclosure is compared with a summary 620 generated through a general summary of the related art 600.

FIG. 8 is a view illustrating a computing device capable of performing the proposed method of the present disclosure.

### DETAILED DESCRIPTION OF THE INVENTION

The present disclosure may be modified in various ways and has various exemplary embodiments. Hereinafter, specific exemplary embodiments will be described in detail on the basis of the attached drawings. The following exemplary embodiments are provided to aid in a comprehensive understanding of a method, device, system, and/or storage medium described in the present specification. However, this is merely examples and the scope of the present disclosure is not limited thereto.

Additionally, in describing the exemplary embodiments of the present disclosure, when it is determined that a detailed description of a known technology related to the present disclosure may unnecessarily obscure the subject matter of the present disclosure, the detailed description thereof will be omitted. In addition, terms to be described later are terms defined in consideration of functions in the present disclosure, which may vary according to the intention, custom, etc. of users or operators. Therefore, definitions of these terms should be made on the basis of the content throughout the present specification. The terms used in the detailed description are only for describing the exemplary embodiments of the present disclosure, and should not be construed as limiting in any way. Unless expressly used otherwise, expressions in the singular form include the meanings in the plural form. In the present description, expressions such as “comprising”, “including”, or “provided with” are intended to indicate certain characteristics, numbers, steps, operations, elements, and any part or combination thereof, and it should not be construed to exclude the existence or possibility of one or more other characteristics, numbers, steps, operations, elements, and any parts or the combinations thereof other than those described above.

In addition, although terms “first”, “second”, etc. may be used herein to describe various components, these components should not be limited by these terms, and the terms are used solely to distinguish one component from another.

### System Overview

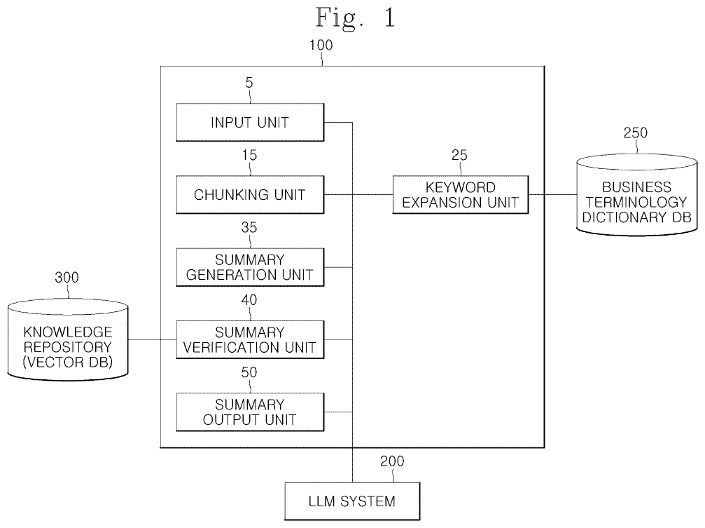

FIG. 1 is a schematic view illustrating a configuration of a summary system 100 configured to perform a method for summarizing information based on user-specified keywords by utilizing generative AI according to one exemplary embodiment of the present disclosure. The exemplified summary system 100 includes an input unit 5, a chunking unit 15, a keyword expansion unit 25, a summary generation unit 35, a summary verification unit 40, and a summary output unit 50, and may interwork with an LLM system 200, a business terminology dictionary database 250, a knowledge repository 300, and the like, which are built inside or outside the summary system 100.

The input unit 5 is for receiving summary target information and one or more keywords, which are specified or input from a user. The summary target information may be, for example, various documents and the like that are generated or managed through various collaboration systems (e.g., drives, mails, messengers, etc.) built within an organization, company, department, or the like to which a user belongs. Here, the documents may be, for example, electronic document files, emails, messenger texts, and the like, but are not limited thereto.

As described above, the chunking unit 15 is used for dividing summary target information, which is specified or input by a user, in units of chunks. Here, a chunk unit broadly refers to each unit of the summary target information divided through appropriate processing, and for example, this may be a unit able to be input all at once into generative AI 200 such as an LLM and of which the context is understandable by the generative AI 200.

As described above, the keyword expansion unit 25 is for performing a function of clustering one or more keywords specified or input by a user into one or more keyword groups according to the semantic relevance of each keyword on the basis of the generative AI 200, and/or a function of keyword expansion for adding, to a corresponding keyword group, one or more terms (e.g., those defined in a business terminology dictionary database 250 built within an organization, company, department, or the like to which the user belongs) related to each keyword belonging to the one or more keyword groups. Here, the operations of the keyword expansion unit 25 and chunking unit 15 are not restricted by sequence and may be performed sequentially or in parallel.

The summary generation unit 35 is for causing the generative AI 200 to generate and return a summary of summary target information (or each chunk) having content related to keywords (or a keyword group), and for collecting and synthesizing the generated summaries, so as to generate a summarization result text.

The summary verification unit 40 is for extracting one or more similar chunks having content similar to that of a summarization result text through a database such as a knowledge repository 300, and causing the generative AI 200 to generate feedback on errors or incorrect parts of the content of the summarization result text on the basis of the extracted similar chunks.

The summary output unit 50 is for outputting, to the user, a final summary, which has been modified by applying the feedback, etc. on the errors or incorrect parts of the generative AI 200.

Each component unit of the exemplary system described above is merely a unit of division for conveniently functionally dividing and describing each process of the present disclosure performed on the basis of one or more computer devices, and is not a description of the physical division of each component such as a processor and memory, which are within the computer device. Below, each process related to the function of each unit described above is described in detail.

### Chunking Process of Summary Target Information

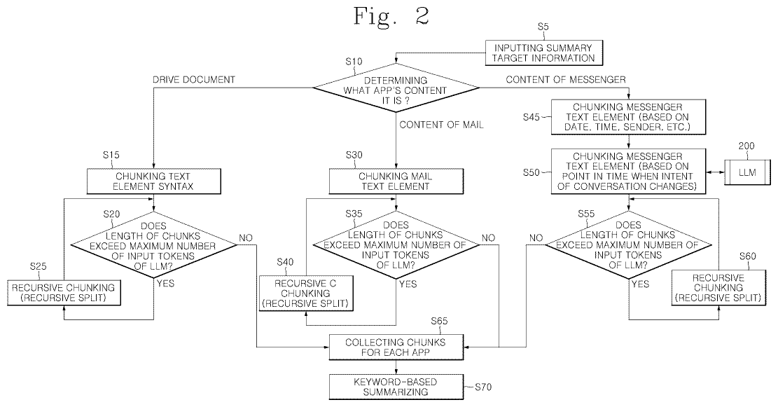

FIG. 2 is a flowchart for describing a chunking process of summary target information such as documents, the chunking process being related to a function of a chunking unit 15. Here, with respect to the summary target information (e.g., documents, mails, messengers, etc.) selected by a user, chunking may be a method of dividing each piece of the summary target information into smaller segments in order to divide it into units to be input into an LLM. For example, the chunking may be a method of dividing the summary target information into units of chunks able to be input into the LLM all at once and of which the contexts are understandable by the LLM.

The present inventors have taken into consideration the fact that the larger the size of text (or token sequence and the like depending on a representation method) to be input into an LLM, the higher the possibility that noise will occur or important phrases will be unclear, structural understanding of document content is more difficult, obtaining a high-quality summary is difficult due to a difficulty in identifying the intent based on contexts, and having the maximum number of input tokens of the LLM is limited, whereby the present inventors propose the configuration as the exemplary embodiment in which summary target information is divided into the units of chunks able to be input into the LLM all at once and of which the contexts are understandable by the LLM.

To this end, first, summary target information is input in step S5, and which content of an application (app) (e.g., a drive, a mail, a messenger, etc.) is the summary target information is checked in step S10, so that a chunking process that matches the characteristics of the corresponding summary target information, such as the type of app in which the corresponding summary target information is generated or managed, may be selectively applied. For example, in a case of summary target information that is a document (i.e., a drive document) stored in a drive, chunking may be performed on the basis of text element syntax in step S15. For example, text structures (i.e., headers, a table of contents, paragraphs, etc.) may be identified, so that the document may be divided on the basis of each structure (e.g., dividing is performed in units of the headers, the table of contents, and the paragraphs, or is sequentially performed from large units to small units). As another example, in a case of summary target information that is an email, chunking may be performed on email text elements in step S30. For example, since forwarding messages such as an original message and a reply message are often attached consecutively in one email, the email may be divided on the basis of each attached message. As a yet another example, in a case of summary target information that is messenger content, chunking may be performed on messenger text elements in steps S45 and S50. For example, the chunking may be performed in a way of dividing the messenger content on the basis of date, time, and sender in step S45, and then dividing is further performed on the messenger content in step S50 by finding a point in time when the intent of conversation changes. In this case, in order to find the point in time when the intent of conversation changes, processing may be conducted by attaching, as context information, each chunk divided in the previous process, so as to request the point in time when the intent of conversation changes from LLM 200 through a prompt and receive a response from the LLM.

In all the cases of three types of summary target information exemplified above, it is determined whether the length of chunks (each length of chunk+the total length of a prompt including a keyword group) exceeds the maximum number of input tokens of the LLM in steps S20, S35, and S55, so that when exceeded, recursive chunking (or recursive split) may be performed in steps S25, S40, and S60. Here, the recursive chunking means further dividing the chunks divided in the previous process in order of paragraphs, sentences, and words. In this case, predetermined restrictions may also be placed on the division so that the content and flow of contexts are not interrupted. In addition, as exemplified in FIG. 2, the end time point of the recursive chunking may also be determined by whether the length of a currently divided chunk exceeds the maximum number of input tokens of the LLM in steps S20, S35, and S55.

In a case where the length of chunks does not exceed the maximum number of input chunks of the LLM, the division is no longer performed, but chunks divided through the process up to that point in time are collected for each app in step S65. In this case, each divided chunk and the tag information about the summary target information from which each corresponding chunk is divided may be combined so as to process the data in the form of a tag-chunk pair. For example, the tag information may serve as a function of identifying which corresponding chunk is divided from the summary target information related to which app (e.g., drive documents, mails, messengers, etc.).

### Keyword Clustering and Expansion Process

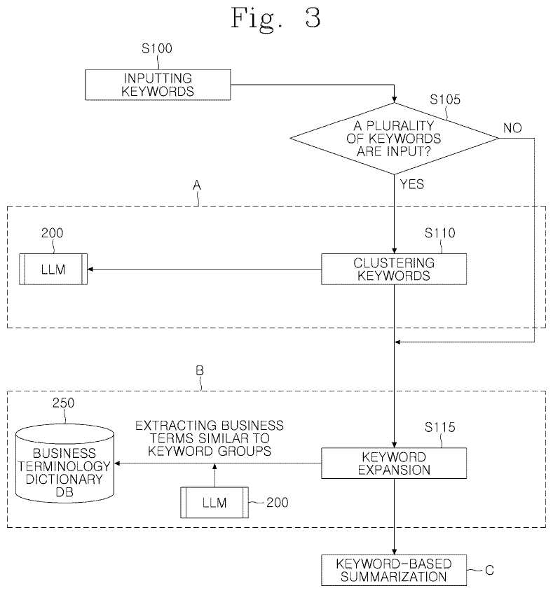

FIG. 3 is a flowchart for describing a keyword clustering process A and expansion process B related to a function of a keyword expansion unit 25. Keywords are input from a user in step S100, and whether a plurality of input keywords has been input is determined in step S105. In a case of the plurality of keywords, the keyword clustering process A is performed on the basis of an LLM 200 in step S110. For example, through a prompt attaching the plurality of input keywords, the LLM 200 may be requested to cluster the keywords into one or more keyword groups and respond with the keyword groups according to the semantic relevance of each keyword. The keyword groups are generated by grouping the keywords having similar semantics through the keyword clustering, so that when a keyword-based summary is generated, the units of keyword groups may be referenced for summary generation, thereby maximally reducing the number of calls to the LLM 200. It is self-evident that during such a clustering process, a case of some keyword groups that include only one keyword each may also occur.

For each keyword group generated in this way, a keyword expansion process B is performed. In step S115 for the keyword expansion process, example, a business terminology for dictionary database 250, etc. built within an organization, company, department, or the like to which a user belongs may be utilized. Through a prompt attaching business terms extracted from the business terminology dictionary database 250 and the corresponding keyword group, the LLM 200 may be caused to transmit a reply by adding, to the corresponding keyword group, one or more business terms related to each keyword belonging to the corresponding keyword group. Through such keyword expansion, each keyword group further include the terms related to the work of the user and/or the work of the organization, company, department, or the like to which the user belongs, so that when a keyword-based summary is generated, the summary applied with the content of the work may be generated.

### Keyword-Based Summary Generation Process

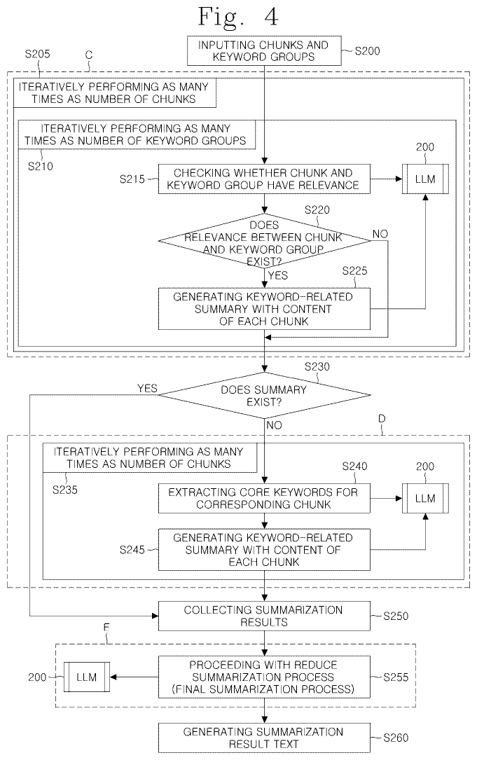

FIG. 4 is a flowchart for describing a keyword-based summary generation process related to a function of a summary generation unit 35. In step S200, inputs that include the chunks of summary target information (or documents), which are generated through the chunking process of the summary target information described above, d keyword groups generated through the keyword clustering and expansion processes described above are received, so that processes of keyword-based summarization C, general summarization D, and final summarization E may be performed.

The keyword-based summarization C may be iteratively performed as many times as the number of chunks in step S205, and may also be iteratively performed as many times as the number of keyword groups for each chunk in step S210. That is, the keyword-based summarization C may be iteratively performed as many times as a number that equals to the number of chunks×the number of keyword groups. In the present exemplary embodiment, in order to increase the accuracy of summarization, for each (chunk, keyword-group) pair, the LLM 200 is utilized to check whether there is relevance between a corresponding chunk and a corresponding keyword group. First, in step S215, the LLM 200 is requested to respond in binary (0 or 1) about the relevance of the corresponding (chunk, keyword-group) pair. This is, for example, requesting an answer having “1” (relevant) or “0” (not relevant). According to the test of the present inventors, when the LLM 200 is requested to reply with an answer in this way, the response speed is fast, and the accuracy of the answer and the accuracy degree of a summary that followed are also high.

Determination is performed on the basis of the response of the LLM 200 in step S220, so that when the corresponding (chunk, keyword-group) pair is determined to have the relevance therebetween, the LLM 200 is utilized to perform the summarization of the corresponding chunk on the basis of the keyword group in step S225. In this case, since each chunk divided as described above may be in the form of a tag-chunk pair in which a corresponding chunk is combined with tag information about the divided summary target information, the corresponding chunk and the tag information combined with the corresponding chunk may be attached together as context information to a prompt to be input into the LLM 200, thereby further improving the accuracy of summarization.

In this way, the LLM 200 is caused to check whether a keyword group and a chunk have relevance therebetween, and then, in a case where the relevance exists, the LLM 200 is caused to summarize the corresponding chunk on the basis of the corresponding keyword group, so that the required summary information focused on the content related to the corresponding keyword group may be obtained, and an effect of preventing hallucination may also be achieved.

The keyword-based summarization process described above is iteratively performed as many times as a number that equals to the number of chunks×the number of keyword groups in steps S205 and S210, and determination is performed on whether an extracted summary obtained exists in step S230. When it exists, a summary result collection process in step S250 may be performed immediately, and when it does not exist, a general summarization process D may be performed instead of the keyword-based summarization C.

In the general summarization process D, a summary process is iteratively performed as many times as the number of chunks in step S235, core keywords for a corresponding chunk are extracted on the basis of the LLM 200 in step S240, and the LLM 200 is caused to perform summarization for the corresponding chunk by using the content related to the extracted keywords in step S245.

Thereafter, the summary result generated from the keyword-based summarization process C or general summarization process D described above is collected in step S250, and the collected summary result is attached to a prompt so as to proceed with a Reduce summarization (or final summarization) process E through the LLM 200 in step S255. This may be the processes of generating a single summary by combining each summary so as to be naturally linked and mixed with each other and by reorganizing each summary so as to enable the user to easily understand the summary. Through such processes, a summarization result text may be generated in step S260.

### Summarization Result Text Verification Process

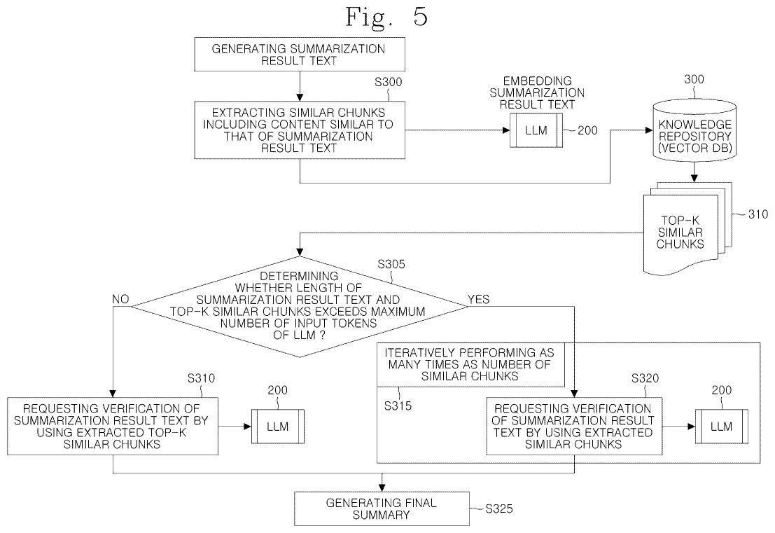

FIG. 5 is a flowchart for describing a summary verification process related to a function of a summary verification unit 40. In the previous processes described above, the summarization result text is generated in step S260, and based on the generated summarization result text, a similar chunk including content similar to that of the summarization result text is extracted in step S300. In these processes, for example, first, the LLM 200 is caused to perform embedding of the summarization result text through a prompt attaching the summarization result text and to reply with a result in the form of an embedded vector. Thereafter, a knowledge repository 300 is queried on the basis of the replied embedded vector, so as to extract k chunks (i.e., Top-k similar chunks 310) that exhibit the highest similarity to the summarization result text. Here, the knowledge repository 300 refers to a vector database (vector DB) for storing numerous chunks of information, which is generated during the work processes of a plurality of users, in the form of vector database. The determination of similarity may be based on calculating cosine similarity between the embedded vector of the summarization result text and each vector stored in the knowledge repository 300.

In addition, determination is performed on whether the length of the summarization result text and extracted Top-k similar chunks 310 exceeds the maximum number of input tokens of the LLM 200 in step S305, so that when exceeded, the process of requesting the LLM 200 to reply with feedback on a part of the summarization result text that appears to be incorrect in light of similar chunks through a prompt including the summarization result text and each similar chunk in step S320 may be iteratively performed as many times as the number of similar chunks in step S315.

In contrast, in a case where the length of the summarization result text and extracted Top-k similar chunks 310 does not exceed the maximum number of input tokens of the LLM 200, the process of requesting the LLM 200 to reply with feedback on a part of the summarization result text that appears to be incorrect in light of Top-k similar chunks through a prompt including the summarization result text and Top-k similar chunks may be performed in step S310.

Through these processes, even in the case where the summary including the incorrect content is generated due to the content of the summary target information (or the document) itself that contains an error, a user may verify that the content of the summary target information may be incorrect in light of the similar chunks in other documents stored in the knowledge repository, thereby enabling the verification of the summarization result text. Through these processes, a final summary may be generated in step S325.

### Example of Final Summary

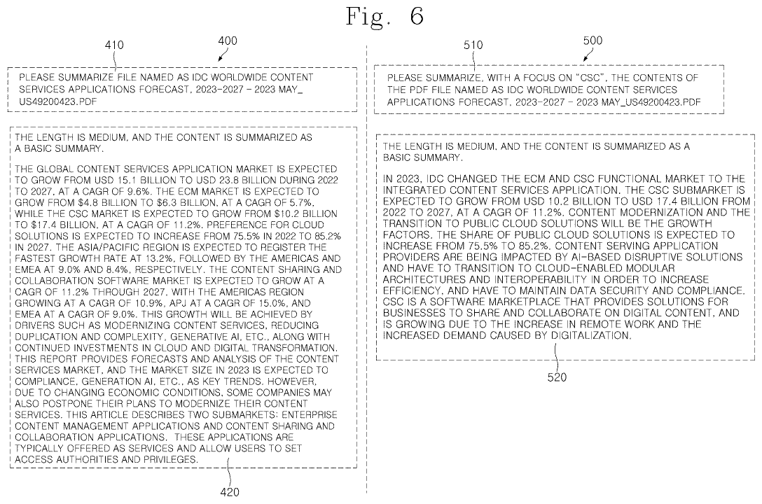

FIG. 6 is a view illustrating that a final summary 520 generated through keyword-based summarization and obtained through the present exemplary embodiment is compared with a summary 420 generated through general summarization in the related art 400. The left side 400 of FIG. 6 shows a final summary 420 obtained by summarizing summary target information (i.e., a document related to a content service application market) through general summarization, and the right side 500 of FIG. 6 shows a final summary 520 obtained by summarizing a summary target document on the basis of a keyword “CSC”, which is Content Sharing and Collaboration. In the case of the final summary 520 according to the keyword-based summarization on the right side, it may be confirmed that a result summarizing the summary target information only to content related to the “CSC” is obtainable. For reference, prompts 410 and 510 for respective cases are shown together.

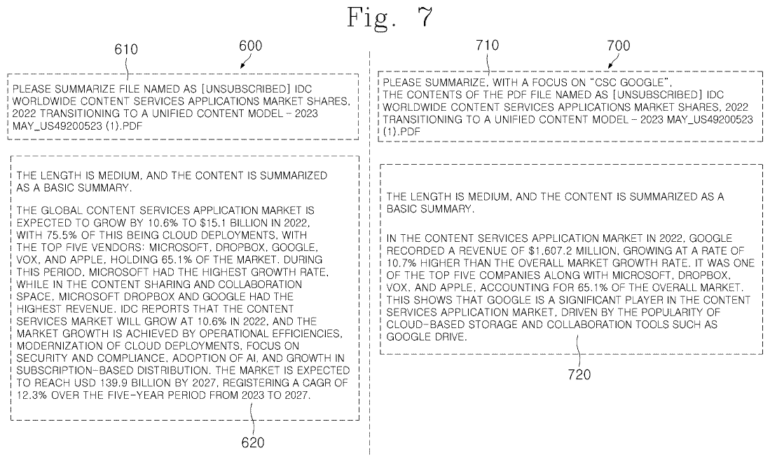

Likewise, FIG. 7 is a view illustrating that a final summary 720 generated through keyword-based summarization and obtained through the present exemplary embodiment is compared with a summary 620 generated through general summarization in the related art 600. The left side 600 of FIG. 7 shows a final summary 620 obtained by summarizing summary target information (e.g., a document related to the content service application market) through general summarization, and the right side 700 of FIG. 7 shows a final summary 720 obtained by summarizing a summary target document on the basis of the keyword “Google”. In the case of the final summary 720 according to the keyword-based summarization on the right side, it may be confirmed that a result is summarized only with content related to “Google”. For reference, prompts for respective cases 610 and 710 are shown together.

Device Applicable with Proposed Method of Present Disclosure

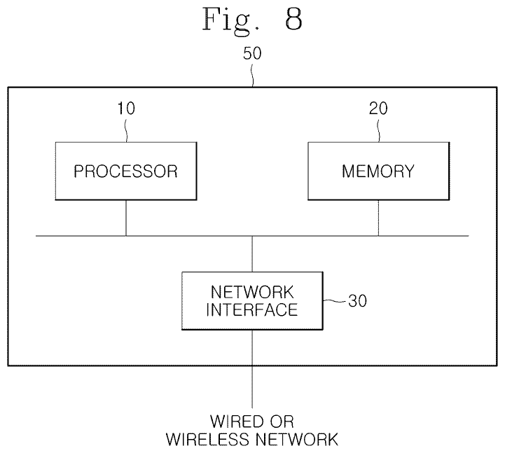

FIG. 8 is a view illustrating a computing device 120 capable of performing the proposed method of the present disclosure.

Referring to FIG. 8, a device 120 may be configured to implement the proposed method of the present disclosure. For example, the device 120 may be a computing device, a server device, a terminal device, a network device, etc. for performing the process of the present disclosure.

For example, the device 120 to which the proposed method of the present disclosure may be applied may include: network devices such as repeaters, hubs, bridges, switches, routers, gateways; computer devices such as desktop computers, workstations; mobile terminals such as smartphones; portable devices such as laptop computers; home appliances such as digital TVs; and mobility means such as automobiles. As another example, a device 120 to which the present disclosure is applicable may be included as part of an Application Specific Integrated Circuit (ASIC) implemented in the form of a System On Chip (SoC).

The memory 20 may be connected to the processor 10 during operation, may store programs and/or instructions for processing and controlling the processor 10, and may store: data and information used in the present disclosure; control information required for data and information processing according to the present disclosure; temporary data generated during the data and information processing; and the like. The memory 20 may be implemented as a storage device such as a Read Only Memory (ROM), a Random Access Memory (RAM), an Erasable Programmable Read Only Memory (EPROM), an Electrically Erasable Programmable Read-Only Memory (EEPROM), a flash memory, a Static RAM (SRAM), a Hard Disk Drive (HDD), a Solid State Drive (SSD), etc.

The processor 10 may be operatively connected to the memory 20 and the network interface 30, and controls the operation of each module within the device 120. In particular, the processor 120 may perform various control functions for performing the proposed method of the present disclosure. The processor 120 may also be called a controller, a microcontroller, a microprocessor, a microcomputer, a Graphic Processing Unit (GPU), etc. The proposed method of the present disclosure may be implemented by hardware, firmware, software, or a combination thereof. When the present disclosure is implemented by using the hardware, the processor 10 may be provided with an application specific integrated circuit (ASIC) or a digital signal processor (DSP), a digital signal processing device (DSPD), a programmable logic device (PLD), a field programmable gate array (FPGA), etc., which are configured to perform the present disclosure. Meanwhile, when the proposed method of the present disclosure is implemented by using the firmware or software, the firmware or software may include instructions related to modules, procedures, or functions that perform functions or operations required for implementing the proposed method of the present disclosure. The instructions may be stored in the memory 20 or be stored in a computer-readable recording medium (not shown) separate from the memory 20, so as to be configured to cause the device 120 to implement the proposed method of the present disclosure when executed by the processor 10.

In addition, the device 120 may include a network interface device 30. The network interface device 30 is connected to the processor 10 when in operation, and the processor 10 controls the network interface device 30, so as to transmit or receive wireless/wired signals carrying information and/or data, signals, messages, and the like through a wireless/wired network. For example, the network interface device 30 supports various communication standards such as, IEEE 802 series, 3GPP LTE(-A), 3GPP 5G, and may transmit and receive control information and/or data signals according to a relevant communication standard. The network interface device 30 may also be implemented outside the device 120 as required.

According to the present disclosure, a summary focused on information related to keywords specified by a user is provided by utilizing generative AI such as an LLM, so as to enable the user to obtain satisfactory summary information that accurately matches the user's intention and specific situation such as work.

In addition, there is provided the method for effectively summarizing various types of information of collaboration systems (e.g., drives, mails, messengers, etc.) built within an organization, company, department, or the like to which a user belongs, on the basis of keywords input or specified by the user by utilizing generative AI such as an LLM.

In addition, according to the present disclosure, there is provided the method for utilizing generative AI such as an LLM, so as to group keywords input from a user by combining the keywords with high semantic relevance, to further expand each grouped keyword by extracting keywords that have high semantic relevance and are related to the work of an organization, company, department, or the like to which the user belongs, and to perform summarizing on the basis of keyword groups expanded in this way, thereby providing customized summary information that matches the requirements or work characteristics of the individual user or the organization, company, or department to which the user belongs.

In addition, there is provided the summary verification method configure to extract a context semantically similar to a summary by utilizing a database such as a knowledge repository on the basis of an LLM for the generated summary, and further compare extracted context with the summary by utilizing the LLM, so as to find errors or incorrect parts in the summary, thereby improving the reliability of the generated summary.

The effects of the present disclosure are not limited to the above-described effects, and other effects that are not described will be clearly understood by those skilled in the art from the following content described in the present specification.

The exemplary embodiments described above are those in which the components and features of the present disclosure are combined in a predetermined form. Each component or feature should be considered optional unless otherwise explicitly stated. Each component or feature may be implemented in a form that is not combined with other components or features. In addition, configuring the exemplary embodiments of the present disclosure may also be applicable by combining some components and/or features. The order of the operations described in the exemplary embodiments of the present disclosure may be changed. Some components or features of any one exemplary embodiment may be included in another exemplary embodiment, or may be replaced with corresponding components or features of another exemplary embodiment. It is self-evident that claims that do not have an explicit citation relationship in the scope of the patent claims may be combined so as to configure an exemplary embodiment, or may be included as a new claim through a post-filing amendment.

What is claimed is:

1. A method performed by a computing device and for summarizing information based on user-specified keywords using generative AI, the method comprising:
an input step of receiving summary target information and one or more keywords, which are specified or input from a user;
a summary generation step of causing the generative AI to generate and return a summary of the summary target information with content related to the keywords based on the keywords and the summary target information; and
a summary output step of providing a final summary to the user based on the summary returned by the generative AI.

2. The method of claim 1, wherein the summary target information is one or more documents, and
the one or more documents include at least one of electronic document files, emails, or messenger texts.

3. The method of claim 2, further comprising:
a chunking step of dividing the documents into units of chunks able to be input into the generative AI all at once and able to understand contexts by the generative AI.

4. The method of claim 3, further comprising:
a chunk collection step of collecting the chunks, which are obtained by the division, by combining each chunk with tag information about the divided documents.

5. The method of claim 1, further comprising:
when a plurality of keywords are input by the user,
a keyword clustering step of causing the generative AI to cluster the plurality of keywords as a basis into one or more keyword groups according to semantic relevance of the plurality of keywords.

6. The method of claim 5, further comprising:
a keyword expansion step of causing the generative AI to recommend one or more terms related to each keyword belonging to the one or more keyword groups so as to add the terms to the keyword groups, on the basis of the one or more keyword groups.

7. The method of claim 6, wherein the terms related to each keyword are the terms related to work of an organization or company to which the user belongs.

8. The method of claim 1, further comprising:
a chunking step of dividing the summary target information into units of one or more chunks; and
a keyword clustering step of generating one or more keyword groups based on the one or more keywords input by the user,
wherein the summary generation step comprises:
a relevance determination step of causing the generative AI to determine relevance between the respective chunks and keyword groups, based on the respective chunks and keyword groups.

9. The method of claim 8, wherein the summary generation step further comprises:
a chunk summary generation step of requesting the generative AI to generate and return a summary of each chunk with content related to each keyword group when the respective chunks and keyword groups are determined to have the relevance on the basis of relevance determination results.

10. The method of claim 9, wherein the summary generation step further comprises:
a summarization result text generation step of requesting the generative AI to summarize and organize one or more chunk summaries and generate a summarization result text, on the basis of the one or more chunk summaries obtained by iteratively performing the relevance determination step and chunk summary generation step for each combination of the one or more chunks and the one or more keyword groups.

11. The method of claim 1, further comprising:
a similar chunk extraction step of causing the generative AI to extract one or more chunks having content similar to that of the summary from a database, on the basis of the summary generated in the summary generation step.

12. The method of claim 11, further comprising:
a summarization verification step of causing the generative AI to generate feedback on an incorrect part of the content of the summary, on the basis of the extracted similar chunks.

13. A device comprising:
a processor; and
a memory,
wherein the memory comprises:
instructions configured to cause the device to implement specific operations for summarizing information based on user-specified keywords by utilizing generative AI when executed by the processor, and
the specific operations comprise:
an input operation of receiving summary target information and one or more keywords, which are specified or input from a user;
a summary generation operation of causing the generative AI to generate and return a summary of the summary target information with content related to the keywords based on the keywords and the summary target information; and
a summary output operation of providing a final summary to the user based on the summary returned by the generative AI.

14. The device of claim 13, wherein the summary target information is one or more documents, and
the one or more documents include at least one of electronic document files, emails, or messenger texts.

15. The device of claim 14, the specific operations further comprise:
a chunking operation of dividing the documents into units of chunks able to be input into the generative AI all at once and able to understand contexts by the generative AI.

16. The device of claim 13, wherein, when a plurality of keywords are input by the user, the specific operations further comprise:
a keyword clustering operation of causing the generative AI to cluster the plurality of keywords as a basis into one or more keyword groups according to semantic relevance of the plurality of keywords.

17. The device of claim 13, wherein the specific operations further comprise:
a chunking operation of dividing the summary target information into units of one or more chunks; and
a keyword clustering operation of generating one or more keyword groups based on the one or more keywords input by the user,
wherein the summary generation operation comprises:
a relevance determination operation of causing the generative AI to determine relevance between the respective chunks and keyword groups, based on the respective chunks and keyword groups.

18. The device of claim 17, wherein the summary generation operation further comprises:
a chunk summary generation operation of requesting the generative AI to generate and return a summary of each chunk with content related to each keyword group when the respective chunks and keyword groups are determined to have the relevance on the basis of relevance determination results.

19. The device of claim 18, wherein the summary generation operation further comprises:
a summarization result text generation operation of requesting the generative AI to summarize and organize one or more chunk summaries and generate a summarization result text, on the basis of the one or more chunk summaries obtained by iteratively performing the relevance determination operation and chunk summary generation operation for each combination of the one or more chunks and the one or more keyword groups.

20. A computer-readable storage medium storing one or more programs for execution performed by one or more processors of a computing device, the one or more programs comprising instructions of:
receiving summary target information and one or more keywords, which are specified or input from a user;
causing the generative AI to generate and return a summary of the summary target information with content related to the keywords based on the keywords and the summary target information; and
providing a final summary to the user based on the summary returned by the generative AI.
